(19) United States
(12) Patent Application Publication
(10) Pub. No.: US 2005/0071144 A1
(43) Pub. Date: Mar. 31, 2005

(54) Method for providing VITAL model of embedded memory with delay back annotation

(75) Inventors: Nai-Yin Sung, HsinChu (TW); Tsung-Yi Wu, Changhua City (TW)

Correspondence Address: STEPHEN B. ACKERMAN, 28 DAVIS AVENUE, POUGHKEEPSIE, NY, 12603, US

(73) Assignee: Taiwan Semicondutor Manufacturing Co.

(21) Appl. No.: 10/671,259

(22) Filed: Sep. 25, 2003

(51) Int. Cl. G06F 17/50

(52) U.S. Cl. 703/19

(57) ABSTRACT

A method for modeling a memory with delay back annotation in accordance with the VITAL application specific integrated circuit modeling specification begins with modeling the memory with a timing generic and a port declaration. The wire delay of the memory is then modeled, followed by modeling a timing check for the memory. The wire delay of the model of the memory is then created. A description of the functional operation of the memory is then generated. The path delay for the address, control, and data bus signals to the memory is formed by overloading the VITAL path delay procedures. The VITAL timing check procedures are overloaded to determine timing constraint violations of the timing bus signals of the memory. The VITAL wire delay procedures are overloaded to determine interconnection delay bus signals of the memory.

### BACKGROUND OF THE INVENTION

1. Field of the Invention

This invention relates generally to electronic design automation systems and methods. More particularly, the present invention relates to design, simulation, and modeling of memory circuits within application specific integrated circuits (ASIC) with delay back annotation using VITAL (VHDL Initiative Towards ASIC Libraries).

2. Description of Related Art

Electronic design automation (EDA) systems and methods are presently utilized for the design and verification of electronic integrated circuits, modules containing one or more integrated circuit chips, and printed circuit boards onto which the modules are mounted. Further, the EDA systems and methods are employed in the overall design and verification of electronic systems that contain one or more printed circuit boards.

EDA systems and methods currently make use of VHDL (VHSIC Hardware Description Language). VHDL is a standard programming language for describing the structure and function of electronic systems that arisen from the United States Government's Very High Speed Integrated Circuits (VHSIC) program, initiated in 1980. VHDL has been adopted as a standard (IEEE-STD-1076) by the Institute of Electrical and Electronic Engineers (IEEE).

VHDL allows description of the structure of a design. The structure of the design may then be decomposed into sub-designs. The description then includes the interconnections of the sub-designs. Having the description of the structure of the designs in a familiar programming language form allows the design to be simulated before being manufactured. The simulation permits the designers to quickly compare alternatives and test for correctness without the delay and expense of hardware prototyping.

“A Tutorial Introduction to VITAL”, Steven E. Schulz, P. E., Presented at the 1995 Mentor Users' Group Conference, Oct. 24, 1995 provides a description of the proposed VITAL specification and is summarized in part hereinafter.

During the early 1990's, as ASIC gate densities increased dramatically, there were higher levels of abstraction in the design of electronic systems.

Those companies creating EDA methods and systems were making rapid advances in circuit synthesis. With increasing improvements in computing systems, communication systems, and other electronic applications, there were increased pressure to reduce the design cycle time. VHDL was not able to advance with the requirements because of a lack of an ASIC design methodology, a simulation performance bottleneck, insufficient timing accuracy for verification of design before manufacture, and there were no standard ASIC circuit and sub-circuit libraries. To ameliorate these problems, the VHDL Initiative Towards ASIC Libraries (VITAL) was formed. The VITAL specification was adopted by the IEEE as IEEE STD-1076.4 in 1995 and is incorporated herein by reference.

The purpose of VITAL was to accelerate the availability of ASIC libraries across EDA manufactureres of VHDL simulators. The priorities of the VITAL ASIC libraries were to provide (1) high accuracy for sub-micron ASICs, (2) fast simulation performance; and (3) an aggressive schedule. The VITAL specification consists of standardized:
Timing Routines
Primitive models
Instance Delay Loading Mechanism
Model Development Guidelines Document.

The VITAL specification provided ASIC designers improved portability of designs and libraries across EDA tools, fast simulation performance without leaving VHDL design environment, and the ability to use standard VITAL routines in user-written models. The advantages for integrated circuit manufactureres are that a single library supports all major EDA simulation environments; there is high-accuracy timing support for deep sub-micron circuit designs, and consequently reduced development and maintenance costs. The standard libraries of the VITAL specification allow EDA Vendors to focus on tool and design issues rather than libraries. The standard modeling techniques allow improved optimization and reduced complexity.

The VITAL specification allows flexible specification of functionality with table lookup primitives (w/ multiple outputs), Boolean primitives (specific number of inputs or programmable number of inputs), and behavioral or concurrent style. Further, the VITAL specification allows accurate specification of timing delays. The timing delays may be pin-to-pin or distributed, state-dependent, or conditional. Accurate timing check support is created by having setup and hold timing verification (including negative constraints), recovery/removal checks, minimum pulsewidth, period checks, glitch on event, glitch on detect, and no glitch elements.

The VITAL specification of 1995 does not provide a method of modeling a memory, particularly, a static random access memory (SRAM) or a Flash non volatile random access memory (Flash NVRAM). “The Standard VITAL ASIC Modeling Specification” (VITAL 2000) IEEE 1076.4, February 2001, provides support for all types of SRAM and ROM memories - single, dual port, and multi-port architectures with synchronous and asynchronous operation. The VITAL 2000 specification provides support for:
bit/sub-word/word addressability.
timing and functional violations.
   corruption handling, contention policies.
   address validation for out of range, or invalid value.
   negative timing constraints.
   memory initialization from an external file.
   standard delay format (SDF) back annotation.

“VHDL Sign-Off Simulation: What Future?,” Bakowski, et al., Proceedings of the VHDL International Users Forum. Spring Conference, 1994, IEEE, May 1994, pp. 136-141, describes that a universal VHDL gate library for ASIC sign-off simulation can be developed, even though the optimized VHDL code for various target simulators may differ. The solution is based on VHDL models written with a unique entity declaration and various architecture bodies targeted at simulators, concentrating on VITAL compliant architectures.

“Standardizing ASIC Libraries in VHDL Using VITAL: a Tutorial,” Krolikoski, Proceedings of the IEEE 1995 Custom Integrated Circuits Conference, IEEE, May 1995, pp. 603-610, provides an overview of the central features of VITAL. Models using several VITAL-compliant styles are presented and discussed.

“IEEE Standard for VITAL Application Specific Integrated Circuit (ASIC) Modeling Specification,” Design Automation Standards Committee of the IEEE Computer Society, USA, IEEE Std 1076.4-1995, May 1996, defines the VITAL (VHDL Initiative Towards ASIC Libraries) ASIC Modeling Specification.

U.S. Pat. No. 6,026,226 (Heile, et al.) describes a technique for allowing local compilation at any level within a design hierarchy tree for a programmable logic device. The technique allows a user to compile an entire design using inherited parameter values and assignments from any parent nodes within the design hierarchy tree.

U.S. Pat. No. 5,875,111 (Patel) describes a method of modeling a pull-up device and a pull-down device with delay back annotation in accordance with the VITAL application specific integrated circuit modeling specification.

U.S. Pat. No. 6,141,631 (Blinne, et al.) describes a method for determining the behavior of a VHDL model of a logic cell, which receives input signals resulting in a narrow pulse or “glitch.” If the pulse width of the output pulse is narrower than a pulse rejection period, the output pulse is rejected and is not propagated to subsequent logic cells connected to the output.

### SUMMARY OF THE INVENTION

An object of this invention is to provide a VITAL model for a memory such as an SRAM or a flash NVRAM.

Another object of this invention is to provide a VITAL model of this invention where VITAL path delay procedures are overloaded for timing of address, control, and data bus signals to the memory.

To accomplish at least one of these objects, a method for modeling a memory with delay back annotation in accordance with the VITAL application specific integrated circuit modeling specification begins with modeling the memory with a timing generic and a port declarations. The wire delay of the memory is then modeled, followed by modeling a timing check for the memory. The wire delay of the model of the memory is then created. A description of the functional operation of the memory is then generated. The path delay for the address, control, and data bus signals to the memory is formed by overloading the VITAL path delay procedures. The VITAL timing check procedures are overloaded to determine the timing constraint violations of the timing bus signals of the memory. The VITAL wire delay procedures are overloaded to determine interconnection delay bus signals of the memory.

### BRIEF DESCRIPTION OF THE DRAWINGS

FIG. 1 is a block diagram of an electronic design automation system incorporating a VITAL Model of Embedded Memory with Delay Back Annotation of this invention.

FIG. 2 is a flowchart of a method for designing a VITAL Model of Embedded Memory with Delay Back Annotation of this invention.

FIGS. 3-5 are a flowcharts illustrating the modeling of a path delay of a memory by overloading VITAL path delay procedures.

### DETAILED DESCRIPTION OF THE INVENTION

The design of electronic circuits and systems encompass three fundamental domains: the functional domain, the structural domain, and the geometric domain. The functional domain describes the algorithms performed by the system as expressed in a register transfer language, Boolean equations, and differential equations. The modeling of the functional domain is commonly referred to as behavioral modeling, which describes the functional operation of the system.

The structural domain higher level circuit function that are then further detailed as register, combinatorial, and operational functions, These functions are then detailed as circuits composed of the various electronic components. The higher level circuit functions are described as higher level abstractions within VHDL or as functional circuit blocks within a schematic capture program.

The geometric domain describes the actual floorplan of a system on chip, module, or printed circuit board. The floorplan is then decomposed into the individual components or cells of the system being constructed. The components and the interconnecting wiring are formed to create appropriate levels of polygons representing the description of the levels of materials required to form the electronic components and the interconnecting wiring.

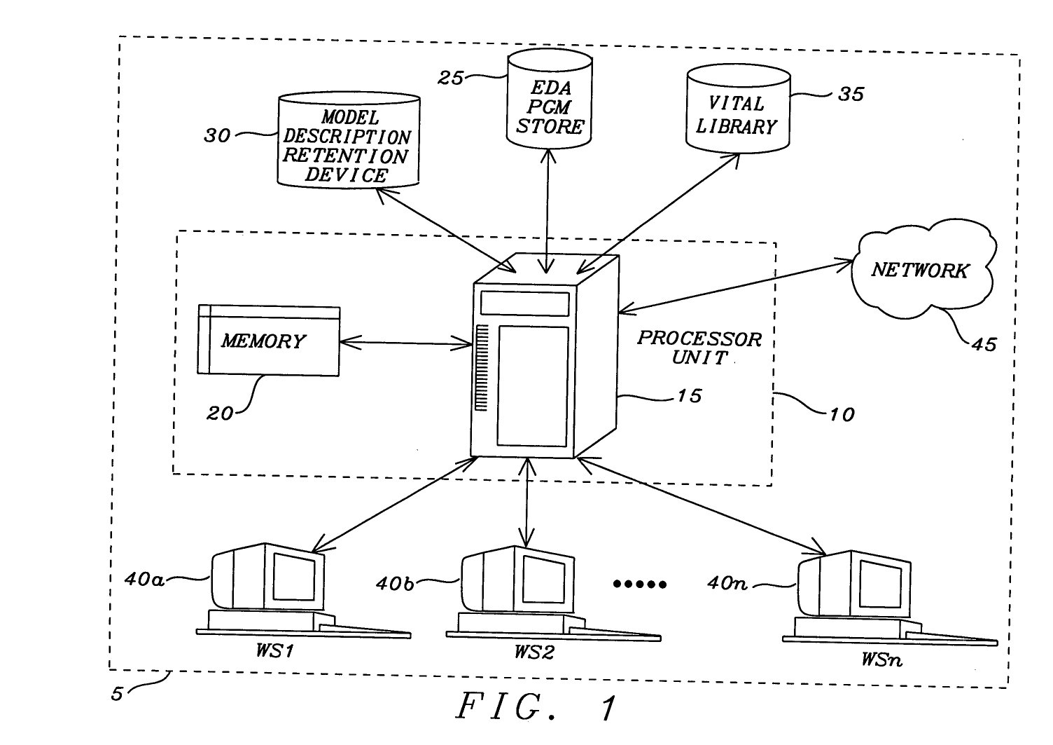

To create the design of electronic circuits and systems, more of the operations and documentation of these designs are performed by computer systems executing programs for defining the functional structure and geometric domains for the circuits and system. An example of an electronic design automation computer system is shown in FIG. 1. The EDA system has a central processor 10 which includes an execution unit 15 and a main memory 20. The central processor retrieves electronic design automation programs from the central program retention device 25, and places the compiled programs in the main memory 20. The electronic design automation programs are executed by using the descriptions of the electronic circuits from the model description retention device 30. The model description calls standardized component and function descriptions from a model library contained on the library retention device.

The model descriptions begin with functional descriptions that are often in a register transfer language. The functional descriptions are then parsed and validated for correctness in order to determine whether the functional description does describe the desired operation. When the functional description is completed, a compiler is often executed on the execution unit 15 to begin the detailing of the electronic design in the structural domain and to create logical and circuit descriptions that detail the electronic components necessary to complete the design. From the structural domain, the electronic components are allocated by physical design programs executed on the execution unit 15 to specific areas of the topography of the physical chip, module, or printed circuit being designed. The EDA physical design programs develop the necessary physical entities that are to be used to manufacture the electronic components within the overall design. Further, as the physical description of the geometric domain is created, the electrical characteristics, such as power dissipation, current requirements, time delays of the circuits and components are determined and referred back or back annotated to the structural domain and the functional domain for further simulation of the functional performance to verify the correctness of the design.

Each program provides a domain for the design that causes the execution unit 15 to essentially function as an independent machine that performs the appropriate functions to create the various parts of the functional, structural, and geometric domains. The processor 10 is connected to workstations 40a, 40b, . . . , 40n such that the designer of the electronic circuit or system can monitor and provide necessary information and modification during the progress of the design. Further, the processor 10 may be connected to a network 45 such that either other EDA computing systems or other workstations may be allowed access to the EDA programs, the model libraries, or the electronic circuit designs.

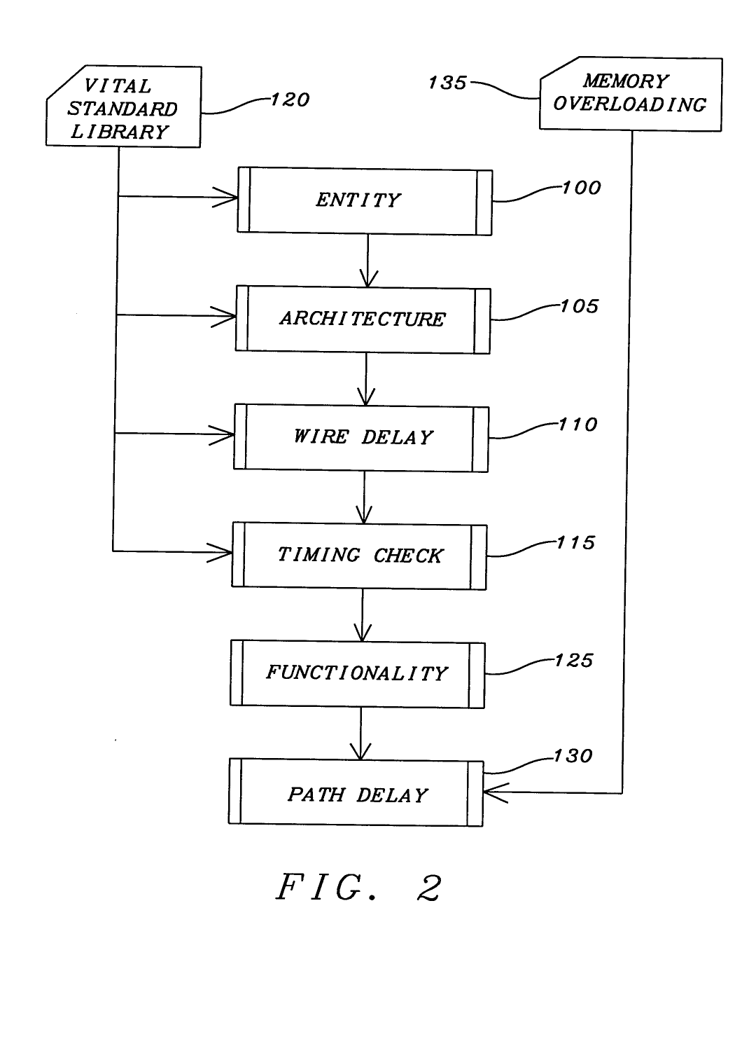

Refer now to FIG. 2 for a description of the flow of the program processes as executed on the processor 10 of FIG. 1. As described above, VHDL is a hardware description language that is employed to assist the design of electronic circuits and systems. The syntax and format of VHDL, as defined in the IEEE Std. 1076, allows a designer to describe the functional entities (Box 100) of the electronic circuit or system being designed. The VITAL standard library (Box 120) provides the standard structure of generalized electronic components provided particularly by ASIC manufacturers. The VITAL standard library (Box 120) is used to assist the designer to create the necessary entities for the electronic design. Once the functional and structural entities (Box 100) are created, the basic architecture (Box 105) of the physical geometric design is created. Again, the VITAL standard library (Box 120) contains the fundamental geometric description for each of the entities of the design as provided by the creator of the library (ASIC manufacturer). From the geometric descriptions of the interconnections of the design, an estimate of the interconnection wiring lengths is created and from the wiring lengths, the delay resulting from the circuit interconnections or wire delay is calculated (Box 110). The modeled circuit delays from the VITAL standard library (Box 120) and the wire delays are collected to generate a timing check (Box 115) to validate that the circuit meets the necessary timing objectives.

Generics within the entities of models that comply with the VITAL specification provide specific kinds of timing and control information. In the preferred embodiment of this invention for an SRAM or NVRAM VITAL description, the timing generics created (Box 100) within the entities for the SRAM or NVRAM are described as follows:

```
tpd_XE_DOUT  : VitalDelayArrayType01Z(numOut-1 downto
    0):=(others =>(Txa, Txa, Txa Txa, Txa, Txa));
tpd_YE_DOUT  : VitalDelayArrayType01Z(numOut-1 downto 0)
    :=(others =>(Tya, Tya, Tya, Tya, Tya, Tya));
tpd_OE_DOUT  : VitalDelayArrayType01Z(numOut-1 downto 0)
    :=(others =>(Toa, Toa, Toa, Toa, Toa, Toa));
tpd_SE_DOUT  : VitalDelayArrayType01Z(numOut-1 downto 0)
    :=(others =>(Tya, Tya, Tya, Tya, Tya. Tya));
```

The a timing check (Box 115) functions such as VlTALSetupHoldCheck, VlTALRecoveryRemovalCheck, and VlTALPeriodPulseCheck maybe modeled as follows:

for i in numAddrX-1 downto 0 loop
VitalSetupHoldCheck

| | |
|---|---|
| Violation | =>Tvol_XADR_ERASE_1, |
| TimingData | =>TimingData_XADR_ERASE 1, |
| TestSignal | =>XADR_ipd, |

TestSignalName=> “XADR”,

| | |
|---|---|
| TestDelay | => 0 ns, |
| RefSignal | => ERASE_ipd, |
| RefSignalName | => “ERASE” |
| RefDelay | => 0 ns, |
| HoldHigh | => Tnvh1, |
| CheckEnabled | => (To_X01Z(MAS1_ipd) = ‘1’), |
| RefTransition | => ‘F’, |
| HeaderMsg | =>InstancePath & “/SFB0008_08B9_CORE_INFO”, |
| Xon | => Xon |
| MsgOn | => MsgOn, |
| MsgSeverity | => WARNING); |
| end loop; | |

Once the timing of the interconnected circuits is verified (Box 115), the total functionality (Box 125) of the design is then simulated. Often this involves simulation of individual circuits, the results of which are then passed to a global function simulator such that the entire circuit functionality can be proven.

Once the functioning of the design is verified and the actual geometric design for all the electronic components and the interconnections are completed, the critical paths of the design are then calculated (Box 130). In the VITAL specification, the path delay section provides the procedures that drive ports or internal signals using appropriate delay values. The procedures have provisions for glitch handling, message reporting control, and output strength mapping. Path delay selection within the VITAL specification is modeled with a procedure call statement that invokes one of the path delay procedures—VITALPathDelay, VITALPathDelay01, or VITALPathDelay01Z—defined in the package VITAL_Timing. A path delay procedure selects the appropriate propagation delay path and schedules a new output value for the specified signal.

To assist in thoroughly verifying the functioning of the electron circuit or system, the path delay of the actual physical design must be determined and fed back or back annotated to the model of the circuit such that the simulations for the circuit or system are more accurate. As stated above, the VITAL specification of 1995 does not provide a method of modeling a memory, in particular a static random access memory (SRAM) or a Flash non volatile random access memory (Flash NVRAM). To overcome this problem, this invention provides a method for overloading the path delay procedures of the VITAL specification. An SRAM or NVRAM is described according VITAL specification as shown in the APPENDIX. The path delay procedures are overloaded (Box 135) in order to generate the path delay timings for the input address, data, and control buses and output buses of the SRAM or NVRAM.

Overloading, as is known in the art, allows two procedures written in VHDL to have the same name, provided the number or base types of these parameters differs. When a call to an overloaded procedure is made the number of actual parameters, their order, their base types and the corresponding formal parameter names (if named association is used) are used to determine which subprogram is meant. This permits the standard path delay procedures to be expanded to accommodate the SRAM and NVRAM structure for embedding these structures within an ASIC.

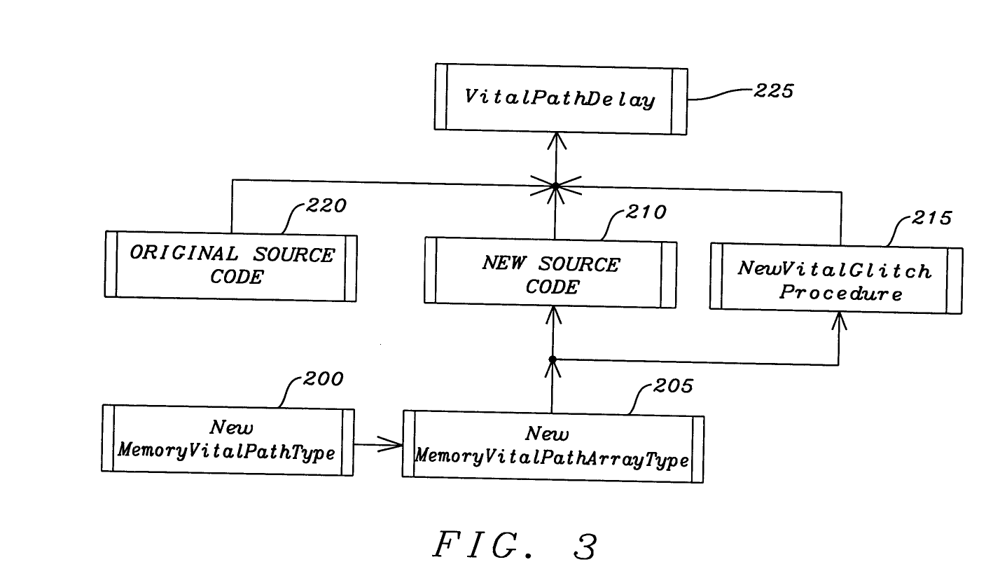

Refer now to FIGS. 3-5 for an explanation of the overloading of the Vital path delay procedures. The predefined path delay procedures VitalPathDelay, VitalPathDelay01, and VitalPathDelay01Z, each provide the following capabilities:
Transition dependent path delay selection.
User controlled glitch detection, “Don't Care (‘X’) generation, and violation reporting.
Scheduling of the computed values on the specified signal.
   Selection of the appropriate path delay begins with the selection of candidate paths. The candidate paths are selected by identifying the paths for which the Path Condition is true. If there is a single candidate path then its delay is the one selected. If there is more than one candidate path, then the shortest delay (accounting for the InputChangeTime parameter) is selected using transition dependent delay selection. If there are no candidate paths then the delay specified by the DefaultDelay parameter to the path delay procedure is used.

The VitalPathDelay and VitalPathDelay01 procedures schedule path delays on signals for which the transition to High Impedance (‘Z’) is not important. These procedures are distinguished from one another by the type of delay values that they accept. The procedure VitalPathDelay is defined for simple path delays of type VitalDelayType. Procedure VitalPathDelay01 is defined for transition dependent path delays of type VitalDelayType01 (rise/fall delays). The Procedure VitalPathDelay01Z schedules path delays on signals for which the transition to or from High Impedance (‘Z’) is important (e.g., modeling of tri-state drivers). In addition to the basic capabilities provided by all path delay procedures, VitalPathDelay01Z performs result mapping of the output value (using the value specified by the actual associated with the OutputMap parameter) before scheduling this value on the signal. This result mapping is performed after a transition dependent delay selection but before scheduling the final output.

In FIG. 3 the VITAL Path Delay procedure is overloaded by first declaring (Box 200) a new MemoryVITALPathTYPE as follows:

Type MEMORYVitalPathType is record
InputChangeTime : time; -- timestamp for path input signal
PathDelay : VitalDelayArrayType(numOut -1 downto 0);--Delay for this
path
PathConditon : Boolean; --path sensitize condition
End record;

The MemoryVITALPathArrayType is then declared (Box 205) as follows:

Type MEMORYVitalPath ArrayType is array (natural range <>) of MEMORYVitalPathType;

The new source code for the new VITAL path delay procedures for determining the path delays for the SRAM and NVRAM is then created (Box 210) according to the following:

Procedure VitalPathDelay (

| Signal | OutSignal | : out std_logic_vector; | |
|---|---|---|---|
| Variable | GlitchData | : inout VitalGlitchDataArrayType; | |
| Constant | OutSignalName: in | | string; |
| Constant | OutTemp | | : in std_logic_vector; |
| constant | Paths | : in | MEMORYVitalPathArrayType; |
| constant | DefaultDelay | : in | VitalDelayType := VitalZeroDelay; |
| constant | Mode | : in | VitalGlitchKindType := OnEvent; |
| constant | XOn | | : in Boolean := true; |
| constant | MsgOn | : in | Boolean := true; |
| constant | MsgSeverity | : in | SEVERITY_LEVEL :=WARNING |
| ) | | | |

At this same time the NewVITALGlitch procedure is created (Box 215) according to the following:

Procedure Vital Glitch (

| | |
|---|---|
| signal OutSignal | : in std_logic_vector; |
| variable GlitchData | : inout VitalGlitchDataArrayType; |
| constant OutSignalName | : in string; |
| constant New Value | : in std_logic_vector; |
| constant NewDelayArray | : in PropDelayArrayType; |
| constant Mode | : in VitalGlitchKindType := On Event; |
| constant XOn | : in Boolean := true; |
| constant MsgOn | : in Boolean := FALSE; |
| constant MsgSeverity | : in SEVERITY_LEVEL := WARNING |
| ) | |

The original source code for the VlTALPathDelay procedure as described in the specification is created (Box 220) and merged with the new source code (Box 210) and the NewVITALGlitch procedure (Box 215) to form (Box 225) the overloaded VlTALPathDelay procedure

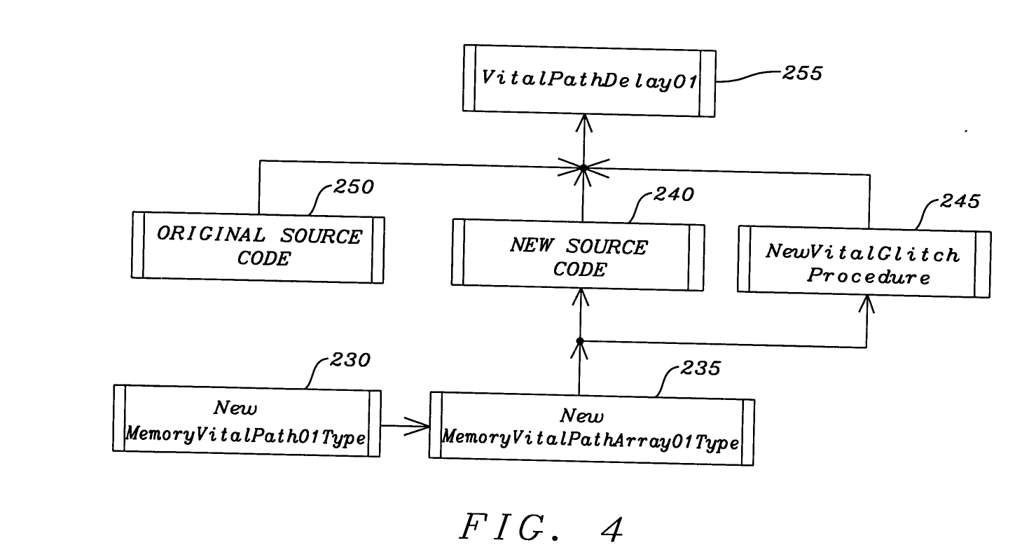

In FIG. 4 the VlTALPathDelay01 procedure is overloaded by first declaring (Box 230) a new MemoryVITALPathType01 as follows:

Type MEMORYVITALPathType01 is record
InputChangeTime : time; -- timestamp for path input signal
PathDelay : VitalDelayArrayType(numOut -1 downto 0);--Delay for this
path
PathConditon : Boolean; --path sensitize condition
End record;

The MemoryVITALPathArrayType is then declared (Box 235) as follows:

Type MEMORYVitalPath ArrayType is array (natural range <> ) of
MEMORYVITALPathType01;

The new source code for the new VITAL path delay procedures for determining the path delays for the SRAM and NVRAM is then created (Box 240) according to the following:

Procedure VitalPathDelay01 (

| Signal | OutSignal | : out std_logic_vector; | |
|---|---|---|---|
| Variable | GlitchData | : inout VitalGlitchDataArrayType; | |
| Constant | OutSignalName: in | | string; |
| Constant | OutTemp | | : in std_logic_vector; |
| constant | Paths | : in | MEMORYVitalPathArrayType; |
| constant | DefaultDelay | : in | VitalDelayType := VitalZeroDelay; |
| constant | Mode | : in | VitalGlitchKindType := OnEvent; |
| constant | XOn | | : in Boolean := true; |
| constant | MsgOn | : in | Boolean := true; |
| constant | MsgSeverity | : in | SEVERITY_LEVEL :=WARNING |
| ) | | | |

At this same time the NewVITALGlitch procedure is created (Box 245) according to the following:

Procedure VitalGlitch (

| | |
|---|---|
| signal OutSignal | : in std_logic_vector; |
| variable GlitchData | : inout VitalGlitchDataArrayType; |
| constant OutSignalName | : in string; |
| constant New Value | : in std_logic_vector; |
| constant NewDelayArray | : in PropDelayArrayType; |
| constant Mode | : in VitalGlitchKindType := On Event; |
| constant XOn | : in Boolean := true; |
| constant MsgOn | : in Boolean := FALSE; |
| constant MsgSeverity | : in SEVERITY_LEVEL := WARNING |
| ) | |

The original source code for the VITALPathDelay01 procedure as described in the specification is created (Box 250) and merged with the new source code (Box 240) and the NewVITALGlitch procedure (Box 245) to form (Box 255) the overloaded VlTALPathDelay01 procedure

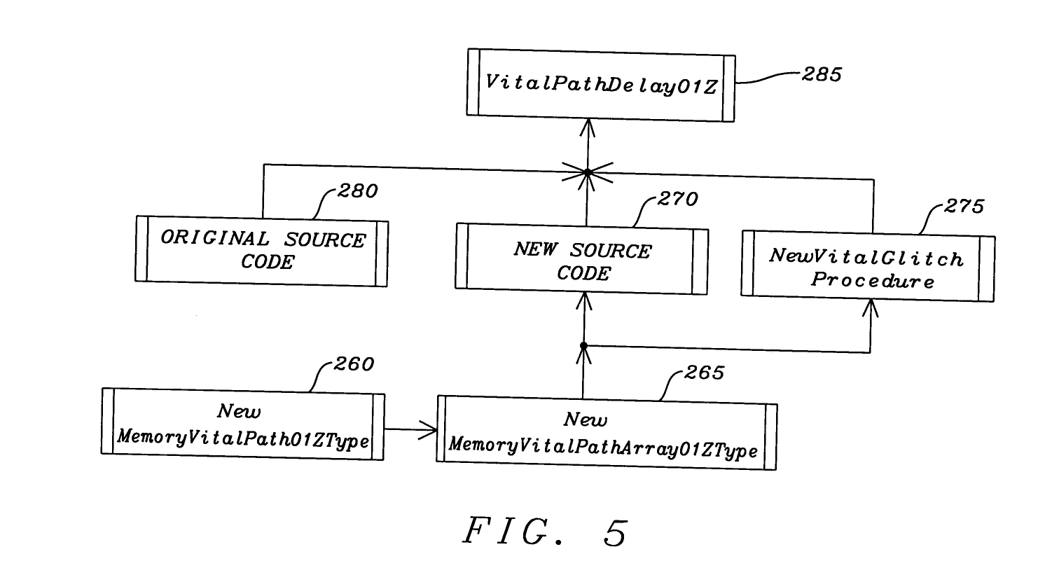

In FIG. 5 the VlTALPathDelay01Z procedure is overloaded by first declaring (Box 260) a new MemoryVITALPathType01Z as follows:

Type MEMORYVITALPathType01Z is record
InputChangeTime : time; -- timestamp for path input signal
PathDelay : VitalDelayArrayType(numOut -1 downto 0);--Delay for this
path
PathConditon : Boolean; --path sensitize condition
End record;

The MemoryVITALPathArrayType is then declared (Box 265) as follows:

Type MEMORYVitalPath ArrayType is array (natural range <>) of MEMORYVITALPathType01Z;

The new source code for the new VITAL path delay procedures for determining the path delays for the SRAM and NVRAM is then created (Box 270) according to the following:

Procedure VitalPathDelay01Z (

| | |
|---|---|
| OutSignal | => DOUT |
| GlitchData | => DOUT_GlitchData, |
| OutSignal Name | => “DOUT”, |
| OutTemp | => DOUT_zd, |
| Paths | => (0 => (XE_ipd'last_event, ZeroDelay, true), |
| | 1 => (YE_ipd'last_event, ZeroDelay, true), |
| | 2 => (OE_ipd'last_event, ZeroDelay, true), |
| | 3 => (SE_ipd'last_event, ZeroDelay, true), |
| | 4 => (XADR_ipd'last_event, ZeroDelay, true), |
| | 5 => (YADR_ipd'last_event, ZeroDelay, true), |
| Mode | =>On Detect, |
| XON | =>XON |
| MsgOn | =MsgOn, |
| MsgSeverity | =>WARNING); |

At this same time the NewVITALGlitch procedure is created (Box 275) according to the following:

Procedure VitalGlitch (

| | |
|---|---|
| signal OutSignal | : in std_logic_vector; |
| variable GlitchData | : inout VitalGlitchDataArrayType; |
| constant OutSignalName | : in string; |
| constant New Value | : in std_logic_vector; |
| constant NewDelayArray | : in PropDelayArrayType; |
| constant Mode | : in VitalGlitchKindType := On Event; |
| constant XOn | : in Boolean := true; |
| constant MsgOn | : in Boolean := FALSE; |
| constant MsgSeverity | : in SEVERITY_LEVEL := WARNING |
| ) | |

The original source code for the VITALPathDelay01Z procedure as described in the specification is created (Box 280) and merged with the new source code (Box 270) and the NewVITALGlitch procedure (Box 275) to form (Box 285) the overloaded VITALPathDelay01Z procedure

While this invention has been particularly shown and described with reference to the preferred embodiments thereof, it will be understood by those skilled in the art that various changes in form and details may be made without departing from the spirit and scope of the invention.

1. A method for modeling a memory with delay back annotation in accordance with the VITAL application specific integrated circuit modeling specification, the method comprising the step of:
modeling a path delay of said memory by overloading VITAL path delay procedures to provide path delay calculations for timing of address, control, and data bus signals to the memory.

2. The method of claim 1 further comprising the steps of:
modeling said memory with a timing generic and a port;
modeling a wire delay of said memory;
modeling a timing check for said memory;
modeling functioning of said memory.

3. The method of claim 1 wherein modeling of said path delay comprises the step of overloading VITAL timing check procedures for determining timing constraint violations of the timing of the address, control, and data bus signals of said memory.

4. The method of claim 1 wherein modeling of said path delay comprises the step of overloading VITAL wire delay procedures for determining interconnection delay of the address, control, and data bus signals of said memory.

5. The method of claim 1 wherein the memory is selected from a grouping of memories consisting of SRAM and Flash NVRAM.

6. An apparatus for modeling a memory with delay back annotation in accordance with the VITAL application specific integrated circuit modeling specification, the apparatus comprising:
means for modeling a path delay of said memory by overloading VITAL path delay procedures to provide path delay calculations for timing of address, control, and data bus signals to the memory.

7. The apparatus of claim 6 further comprising:
means for modeling said memory with a timing generic and a port;
means for modeling a wire delay of said memory;
means for modeling a timing check for said memory;
means for modeling functioning of said memory.

8. The apparatus of claim 6 wherein the means for modeling of said path delay comprises means for overloading VITAL timing check procedures for determining timing constraint violations of the timing of the address, control, and data bus signals of said memory.

9. The apparatus of claim 6 wherein the means for modeling of said path delay comprises means for overloading VITAL wire delay procedures for determining interconnection delay of the address, control, and data bus signals of said memory.

10. The apparatus of claim 6 wherein the memory is selected from a grouping of memories consisting of SRAM and Flash NVRAM.

11. An electronic design automation system for modeling a memory with delay back annotation in accordance with the VITAL application specific integrated circuit modeling specification, the electronic design automation system:
a model library storage device which retains a model of a path delay of said memory, said model of said path delay including an overloading VITAL path delay procedures to provide path delay calculations for timing of address, control, and data bus signals to the memory, said model library storage device connected to an electronic design automation program execution unit that simulates the path delay of said memory.

12. The electronic design automation system of claim 11 further comprising:
a hardware description language storage device connected to the electronic design automation program execution unit, said hardware description language storage device retaining:
models of said memory with a timing generic and a port;
models of a wire delay of said memory;
models of a timing check for said memory;
models of functioning of said memory; and

13. The electronic design automation system of claim 11 wherein the models of said path delay comprise an overloading of VITAL timing check procedures for determining timing constraint violations of the timing of the address, control, and data bus signals of said memory.

14. The electronic design automation system of claim 11 wherein the models of said path delay comprises an overloading of VITAL wire delay procedures for determining interconnection delay of the address, control, and data bus signals of said memory.

15. The electronic design automation system of claim 11 wherein the memory is selected from a grouping of memories consisting of SRAM and Flash NVRAM.

16. A medium for retaining a computer program which, when executed on a computing system, executes an electronic design automation process that describes, evaluates, and simulates a model of a memory with delay back annotation in accordance with the VITAL application specific integrated circuit modeling specification, said electronic design automation process comprising the step of:
modeling a path delay of said memory by overloading VITAL path delay procedures to provide path delay calculations for timing of address, control, and data bus signals to the memory.

17. The medium of claim 16 wherein said electronic design automation process further comprises the steps of:
modeling said memory with a timing generic and a port;
modeling a wire delay of said memory;
modeling a timing check for said memory;
modeling functioning of said memory.

18. The medium of claim 16 wherein modeling of said path delay comprises the step of overloading VITAL timing check procedures for determining timing constraint violations of the timing of the address, control, and data bus signals of said memory.

19. The medium of claim 16 wherein modeling of said path delay comprises the step of overloading VITAL wire delay procedures for determining interconnection delay of the address, control, and data bus signals of said memory.

20. The medium of claim 16 wherein the memory is selected from a grouping of memories consisting of SRAM and Flash NVRAM.
